(19) United States
(12) Patent Application Publication
(10) Pub. No.: US 2005/0088002 A1
(43) Pub. Date: Apr. 28, 2005

(54) Hook-twist & lift grill hooks

(76) Inventor: William J. Dwyer, Whitinsville, MA (US)

Correspondence Address: WILLIAM J. DWYER, 10 WOODLAND STREET, WHITINSVILLE, MA, 01588, US

(21) Appl. No.: 10/694,248

(22) Filed: Oct. 27, 2003

(51) Int. Cl. B65G 7/12

(52) U.S. Cl. 294/26

(57) ABSTRACT

A tool (accessory) for barbecuing for both charcoal and propane grills. This device addresses the problem of being able to remove the top grill (grate) from barbecue grill units both easily and safely. Hook-Twist & Lift grill hooks consist of two handles with engineered metal rods set at a predetermined place on the handle. The placement of the metal rods allow the device to be used on approximately ninety percent of the grills in use at this point in time. The use of Hook-Twist & Lift grill hooks allow for the removal of the top grill (grate) while the grill is in operation and when off. Usage avoids the danger of using implements not specially designed to remove grates which can cause injury to user.

### I. BACKGROUND OF THE INVENTION

The invention concerns that of a device (tool) that is able to remove and replace the top grill (grate) found in both charcoal and gas barbecue cooking units.

### II. DESCRIPTION OF THE PRIOR ART

Not applicable.

### III. SUMMARY OF THE INVENTION

The invention is a device comprised of two handles and four metal rods that can be used to easily and safely remove and replace the top grill (grate) of barbecue grills. The device is designed and engineered to engage the top grate at the middle point where several bars (rods) of the grate are found. By engaging at this point the grill hooks are able to firmly grasp the metal rods enabling the user to remove the grate in such a manner that the grate is always balanced and under control. This ability to remove the top grill (grate) easily and safely eliminates the danger of a hot grill (grate) injuring the user or someone standing by the grill. The device also eliminates the need to use other barbecue tools (forks, tongs etc) that were not designed to remove grates and can be dangerous to use.

This device was designed to fulfill an oblivious void in the marketplace. Investigation (research) has revealed that no similar device existed prior to the invention of Hook-Twist & Lift grill hooks.

Prime advantages of the invention are that:
1. They fit approximately 90% of the grills are the market.
2. They are designed not only with functionality in mind but with affordability, fit, finish and durability also being of upmost concern.
3. The device is simple to use. The marketing concept being its as Simple as 1. Hook 2. Twist (handles) and then 3. Lift

In summary it can be said that Hook-Twist & Lift grill hooks are designed in such a manner as to allow for the quick and easy removal and replacement of the open mesh grills found in barbecue grills both charcoal and propane plus fire grills (camp grills).

The advantages of the invention is apparent after reading through the complete specification, the claims and looking at the attached drawing.

### IV. BRIEF DESCRIPTION OF THE DRAWINGS

FIG. 1 of Drawing 1 Shows a frontal view of a completely assembled H-T-L grill hook one (1) of two (2) in a set.

FIG. 1. of drawing 1. Shows handle marked part a.

FIG. 1. of drawing 1 shows metal rods marked part c inserted into handles at points marked b1 and b2 into metal inserts marked part b. Inserts usually not visible as they are embedded into handles and hidden by metal rod part c but shown here for clarity.

### V, DESCRIPTION OF THE PREFERRED EMBODIMENT

The invention is a device (tool) that is comprised of two wooden handles with metal rods bonded into them. The name of the invention is Hook-Twist & Lift grill hooks and its stated purpose is for the removal and replacement of the top grill (grate) of barbecue cooking units both charcoal and propane quickly and safely.

Use of the grill hooks is simple. 1. The user holds one handle in each hand, places the hook ends over the middle section of the grate where a thick rod running east and west intersects the rods of the grate running north and south. 2. The user then twists the handles towards the outside edges of the grill (to his right and left) this firmly engages the metal hooks against the metal rods of the grill (grate). 3. The user then lifts the grate out of the grill and places it down on a bench or suitable spot. The user now has access to the interior of the grill. If unit is charcoal he can add more charcoal or clean unit safely. If the unit is gas user can clean interior of grill and then clean the grill (grate) itself before replacing the grate to the grill unit.

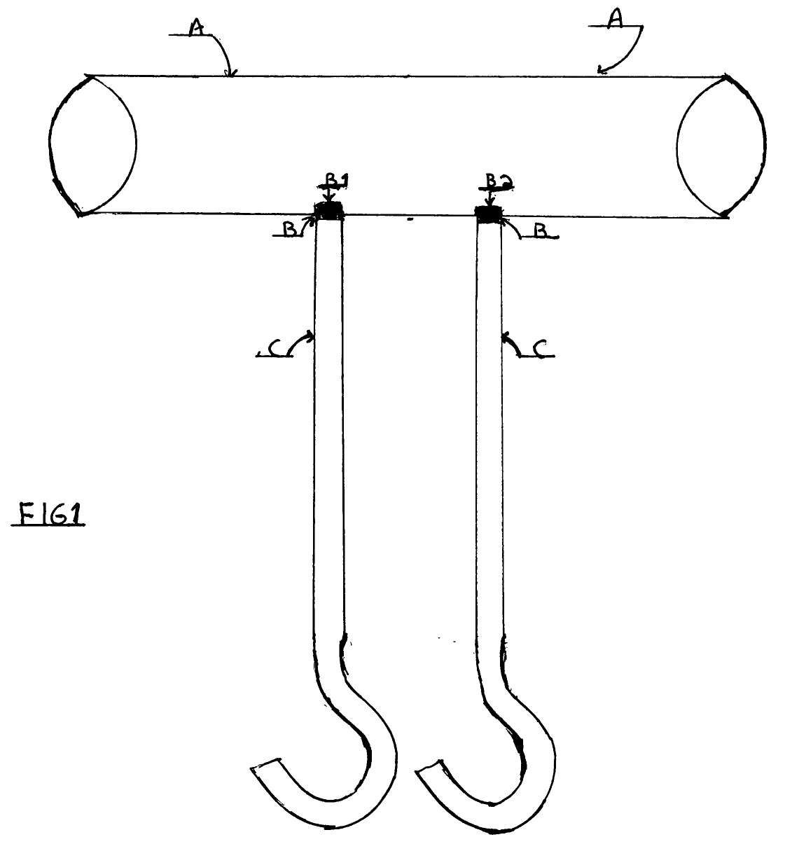

As can be seen by viewing FIG. 1 of drawing 1 the grill hooks only have three (3) parts per handle. The handle part a, the metal inserts part b and the metal rods part c. The handles can be made from metal, plastic or wood but for the barbecue market wood is the preferred material. Wood is the material of choice simply because of its beauty when finished and it's durability. While plastic and metal handles could be manufactured less expensively that is outweighed by the fact that wood holds more attraction to the targeted market and that is the home consumer.

Referring to FIG. 1 again, assembly of the handle is a matter of drilling holes for the metal inserts part b at the predetermined point(s) on the handle at the desired depth to accept the metal rods part. Then the metal rods are inserted into the metal inserts then all parts are bonded into the handles for a permanent fit.

From the foregoing description it is believed that the preferred embodiment achieves the objects of the present invention. Various modifications and changes can be made to the device (Hook-Twist & Lift grill hooks) described above which are apparent to those skilled in the art. These alternatives and modifications are considered to be within the scope of the appended claims and are embraced thereby.

1. A device (tool) designed for the safe and easy removal of top grills (grates) from barbecue units comprised of:
(a) two handles that can be made from wood, metal or plastic material
(b) handle shown in FIG. 1 of the drawing is made of wood one of two handles per set of grill hooks
(c) a device (tool) having two engineered metal rods per handle
(d) referencing 1(c) the metal rods are set at a predetermined place on the handles so that they will properly engage the rods of the top grill (grate)
(e) referencing 1(d) this alignment allows the device to be used on top grills (grates) with open mesh design. That is the metal rods of the grate are spaced apart usually at one inch or more.
(f) referencing 1(c) again at the points where the metal rods enter the body of the handle metal inserts have been bonded into the handle at points b1 and b2 to accept the insertion of metal rods. See also FIG. 1 of drawing.
(g) handle is designed with two concepts in mind 1. For a comfortable fit for the user. 2. To be of sufficient size in order to function yet not be cumbersome in use.

2. A set of grill hooks for the removal of top grill grates as described in claim 1 wherein such hooks will allow for the safe and easy removal and replacement of the grates.
(a) that such handles are designed not only for function but also with appearance and durability in mind.
(b) referencing 2(a) the handle material is a hardwood selected for years of service
(c) referencing 1(f) the metal wood inserts used were designed to match and accept the metal rods referenced in 1(c).
(d) referencing both 1(f) and 2(c) the metal inserts are bonded into the wood handles using a special bonding agent at points b1 and b2.
(e) referencing 1(c) metal rods have been specifically designed, shaped, and altered with their function as the sole purpose.
(f) referencing 1(c) and 2(e) the metal rods are permanently bonded into metal inserts (reference 2(c)) using a specially designed retaining fluid.
(g) that the finish of the handles referenced in 1(b) (FIG. 1), 2(a) and 2(b) be of such quality to ensure a good finish and durability

3. The simple concept or embodiment if you will of using two handles with two metal rods per handle to engage at the middle of a grill grate with the purpose of removing and then replacing said grate easily and safely.
